(19) United States
(12) Patent Application Publication
(10) Pub. No.: US 2015/0116368 A1
(43) Pub. Date: Apr. 30, 2015

(54) METHOD AND DEVICE FOR ADJUSTING CHARACTERS OF APPLICATION

(71) Applicant: Xiaomi Inc., Beijing (CN)

(72) Inventors: Xinyu LIU, Beijing (CN); Zhenwei Wen, Beijing (CN); Yue Cheng, Beijing (CN)

(73) Assignee: Xiaomi Inc.

(21) Appl. No.: 14/585,529

(22) Filed: Dec. 30, 2014

Related U.S. Application Data
(63) Continuation of application No. PCT/CN2013/086566, filed on Nov. 5, 2013.

(30) Foreign Application Priority Data
Dec. 28, 2012 (CN) 201210589852.X

(51) Int. Cl. G06T 3/40; G06T 11/60

(52) U.S. Cl. CPC G06T 3/40; G06T 11/60
USPC 345/668

(57) ABSTRACT

A method for adjusting characters of an application that are displayed on a device, includes: receiving an instruction for adjusting the characters of the application according to a first scaling coefficient; determining whether there is a second scaling coefficient, for the application, that is based on the first scaling coefficient; adjusting the characters of the application according to the first scaling coefficient if it is determined that there is no second scaling coefficient, for the application, that is based on the first scaling coefficient; and adjusting the characters of the application according to the second scaling coefficient if it is determined that there is a second scaling coefficient, for the application, that is based on the first scaling coefficient.

### CROSS-REFERENCE TO RELATED APPLICATIONS

This application is a Continuation Application of International Application No. PCT/CN2013/086566, filed Nov. 5, 2013, which is based upon and claims priority to Chinese Patent Application No. 201210589852.X, filed Dec. 28, 2012, the entire contents of all of which are incorporated herein by reference.

### TECHNICAL FIELD

The present disclosure generally relates to the technical field of display of user interface and, more particularly, to a method and a device for adjusting characters of an application.

### BACKGROUND

With the development of software technology, more and more applications are developed and applied on cell phones, which facilitates and enriches people's lives. However, applications may be limited by the screen size of a cell phone. The more contents to be presented, the smaller a displayed font size will be. Generally, a default word size of an application set on a cell phone can meet most people's requirements. Certain smart cell phones also provide the function of changing the font size of applications to accommodate different users. For example, a cell phone can provide a magnifying setting for the font size to allow users with poor vision to magnify characters of applications.

A conventional method for changing the font size of an application includes the cell phone providing a setting item for a user to select a proportion for scaling up or scaling down characters, such as a 120% magnification or a 150% magnification. The cell phone then scales up or scales down all characters of the application once according to the selected proportion for display, for example, magnifying all characters of the application once to 120% of the original font size. As a result, certain characters may be cropped out of the screen of the cell phone.

### SUMMARY

According to a first aspect of the present disclosure, there is provided a method for adjusting characters of an application that are displayed on a device, comprising: receiving an instruction for adjusting the characters of the application according to a first scaling coefficient; determining whether there is a second scaling coefficient, for the application, that is based on the first scaling coefficient; adjusting the characters of the application according to the first scaling coefficient if it is determined that there is no second scaling coefficient, for the application, that is based on the first scaling coefficient; and adjusting the characters of the application according to the second scaling coefficient if it is determined that there is a second scaling coefficient, for the application, that is based on the first scaling coefficient.

According to a second aspect of the present disclosure, there is provided a device for adjusting characters of an application that are displayed on the device, comprising: a processor; and a memory for storing instructions executable by the processor; wherein the processor is configured to: receive an instruction for adjusting the characters of the application according to a first scaling coefficient; determine whether there is a second scaling coefficient, for the application, that is based on the first scaling coefficient; adjust the characters of the application according to the first scaling coefficient if it is determined that there is no second scaling coefficient, for the application, that is based on the first scaling coefficient; and adjust the characters of the application according to the second scaling coefficient if it is determined that there is a second scaling coefficient, for the application, that is based on the first scaling coefficient.

According to a third aspect of the present disclosure, there is provided a non-transitory computer-readable storage medium having stored therein instructions that, when executed by a processor of a device, cause the device to perform a method for adjusting characters of an application displayed on the device, the method comprising: receiving an instruction for adjusting the characters of the application according to a first scaling coefficient; determining whether there is a second scaling coefficient, for the application, that is based on the first scaling coefficient; adjusting the characters of the application according to the first scaling coefficient if it is determined that there is no second scaling coefficient, for the application, that is based on the first scaling coefficient; and adjusting the characters of the application according to the second scaling coefficient if it is determined that there is a second scaling coefficient, for the application, that is based on the first scaling coefficient.

It is to be understood that both the foregoing general description and the following, detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for adjusting characters of an application, according to an exemplary embodiment.

FIG. 2 is a flowchart of a method for adjusting characters of an application, according to an exemplary embodiment.

FIGS. 3a and 3b are schematic diagrams of a display of applications on a desktop in different font modes, according to exemplary embodiments.

FIGS. 4a, 4b and 4c are schematic diagrams of a display of an address book application in different font modes, according to exemplary embodiments.

FIG. 5 is a block diagram of an apparatus for adjusting characters of an application, according to an exemplary embodiment.

FIG. 6 is a block diagram of an apparatus for adjusting characters of an application, according to an exemplary embodiment.

FIG. 7 is a block diagram of a device for adjusting characters of an application, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

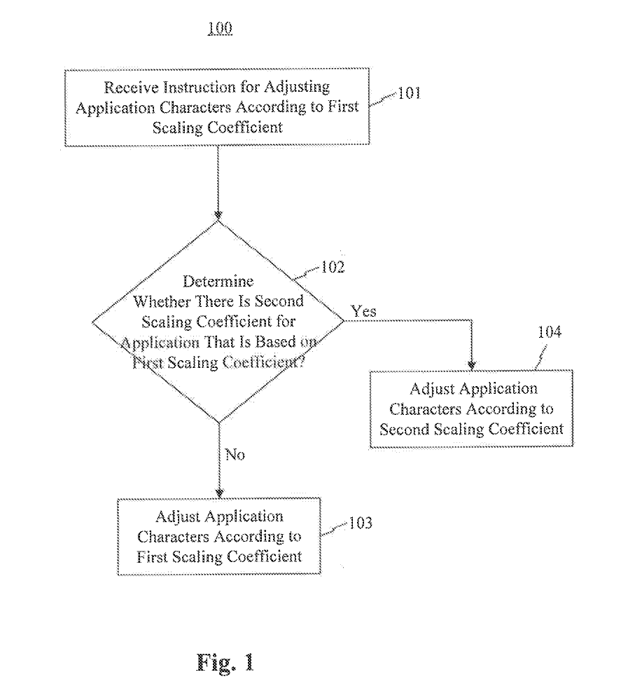

FIG. 1 is a flowchart of a method 100 for adjusting characters of an application that are displayed on a device, referred to hereafter as the application characters, according to an exemplary embodiment. Referring to FIG. 1, the method 100 includes the following steps.

In step 101, the device receives an instruction for adjusting the application characters according to a first scaling coefficient.

For example, the device can receive the instruction for adjusting the application characters according to the first scaling coefficient through a set human-machine interaction interface. The human-machine interaction interface may be a selection menu of scaling coefficients including the first scaling coefficient, a selection icon corresponding to the first scaling coefficient, or a selection key of scaling coefficients.

In one exemplary embodiment, the selection menu of scaling coefficients is provided to a user in a system menu, and the selection menu displays tags of the scaling coefficients, respectively. Accordingly, the user can access the selection menu of scaling coefficients level by level through the system menu to select the first scaling coefficient for adjustment.

In one exemplary embodiment selection icons of respective scaling coefficients are provided to the user on a display interface of the application, and different selection icons correspond to different scaling coefficients. Accordingly, the user can select a scaling coefficient for adjustment by clicking the corresponding selection icon.

In one exemplary embodiment, the selection key of scaling coefficients is provided to the user. Accordingly, the user can select the first scaling coefficient for adjustment by clicking the selection key.

In step 102, the device determines whether there is a second scaling coefficient for the application that is based on the first scaling coefficient.

In one exemplary embodiment, the device obtains descriptive information in a scaling permission description field of the application, and the scaling permission description field is configured to indicate whether there is a second scaling coefficient for the application that is based on the first scaling coefficient. For example, if the device uses an Android operating system, the scaling permission description field may be in an Androidmanifest.xml file. If descriptive information in the Androidmanifest.xml file is true, the device determines that there is a second scaling coefficient for the application that is based on the first scaling coefficient.

The device performs step 103 if it is determined that there is no second scaling coefficient for the application that is based on the first scaling coefficient (102—No). Otherwise (102—Yes), the device performs step 104.

In step 103, the application characters are adjusted according to the first scaling coefficient.

In one exemplary embodiment, consistent with step 103, a font size and a layout of the application characters are adjusted according to the first scaling coefficient. For example, a character library of the application corresponding to the first scaling coefficient is obtained through check ng a stored correspondence between the first scaling coefficient and the character library, and the application characters are adjusted to the obtained character library corresponding to the first scaling coefficient.

In one exemplary embodiment, prior to adjusting the application characters according to the first scaling coefficient, the method 100 may also include determining whether a font size of the application characters after the adjustment will reach a predetermined threshold. If it is determined that the font size of the application's characters will not reach the predetermined threshold, the application characters are adjusted according to the first scaling coefficient. If it is determined that the font size of the application characters will reach the predetermined threshold, the application characters are adjusted to system default characters.

In the illustrated embodiment, the adjustment process is intelligently controlled to adjust the application characters according to the first scaling coefficient, that is, if the font size of the application characters after the adjustment will reach the predetermined threshold, the adjustment is not implemented and the application characters are adjusted to the system default characters, so as to ensure the display effect of the application characters after scaling, and to avoid blurring of the application characters due to over scaling.

In step 104, the application characters are adjusted according to the second scaling coefficient.

In one exemplary embodiment, consistent with step 104, the font size and the layout of the application characters are adjusted according to the second scaling coefficient. For example, a character library of the application corresponding to the second scaling coefficient is obtained through checking a stored correspondence between the second scaling coefficient and the character library, and the application characters are adjusted to the obtained character library corresponding to the second scaling coefficient.

In one exemplary embodiment, prior to adjusting the application characters according to the second scaling coefficient, the method 100 may further include determining whether the font size of the application characters after the adjustment will reach the predetermined threshold. If it is determined that the font size of the application characters will not reach the predetermined threshold, the application characters are adjusted according to the second scaling coefficient. If it is determined that the font size of the application characters will reach the predetermined threshold, the application characters are adjusted according to the first scaling coefficient.

In the above embodiment, the adjustment process is intelligently controlled to adjust the application characters according to the second scaling coefficient, that is, if the font size of the application characters after the adjustment will reach the predetermined threshold, the application's characters are adjusted according to the first scaling coefficient, to ensure the display effect of the application characters after scaling, and to avoid blurring of the application characters due to over scaling.

In the illustrated embodiment, the second scaling coefficient is set according to the first scaling coefficient, such that the application characters may be further adjusted according to the second scaling coefficient after the application characters are adjusted according to the first scaling coefficient. For example, during a process of magnifying the font size of the application characters, the first scaling coefficient is set to 1.1 (that is, the application characters are magnified by a factor of 1.1 on the basis of a system default font size), then the second scaling coefficient may be set to 1.2 (that is, the application characters may be magnified by a factor of 1.2 on the basis of the system default font size), such that after the application characters are adjusted according to the first scaling coefficient, the application may be further magnified according to the second scaling coefficient if allowed.

In the illustrated embodiment, when the device receives the instruction for adjusting the application characters according to the first scaling coefficient and determines that there is a second scaling coefficient for the application that is based on the first scaling coefficient, the device can adjust the application characters according to the second scaling coefficient. If it is determined that there is no second scaling coefficient for the application that is based on the first scaling coefficient, the device can adjust the application characters according to the first scaling coefficient. The application characters are flexibly adjusted, so as to allow the application characters to fit the application's display interface and to prevent the characters from being cropped or forced out of a screen of the device after the adjustment.

In one exemplary embodiment, a plurality of character system modes are set in advance, and each of the character system modes corresponds to a plurality of scaling coefficients in which a next scaling coefficient, e.g., the second scaling coefficient described above, is set according to a previous scaling coefficient, e.g., the first scaling coefficient described above. Table 1 below shows a correspondence between the character system modes and the scaling coefficients.

TABLE 1

| | | Second Scaling |
|---|---|---|
| Character System Mode | First Scaling Coefficient | Coefficient |
| Small Font Mode | 0.9 | 0.8 |
| Standard Font Mode | 1.0 | 1.0 |
| Intermediate Font Mode | 1.1 | 1.2 |
| Large Font Mode | 1.3 | 1.4 |
| Ultra-Large Font Mode | 1.5 | 1.6 |
| . . . | . . . | . . . |

In the illustrated embodiment, the first scaling coefficient is a system default scaling coefficient. The first scaling coefficient may be obtained by statistics according to a proportion of the display interface occupied by the application characters at different values of the font size. The first scaling coefficient is considered a safe scaling coefficient under which the application characters will not be cropped or forced out of the screen. The second scaling coefficient is a selectable coefficient which is indicated in, e.g., the Androidmanifest.xml file of the application and can be set by the application's developers according to the application's own layout. Generally, the set second scaling coefficient may be used to further scale the application characters and to further ensure that the adjusted application characters will not be cropped or forced out of the screen.

Additionally, in the illustrated embodiment, the scaling threshold is also provided. If the application characters after the adjustment will reach the scaling threshold, the application characters will not be adjusted according to any scaling coefficient. The application characters are adjusted according to a determined scaling coefficient, such as the first scaling coefficient or the second scaling coefficient, only when the application characters after the adjustment will not reach the scaling threshold, so as to ensure the display effect of the application characters after scaling and to avoid blurring of the application characters due to over scaling.

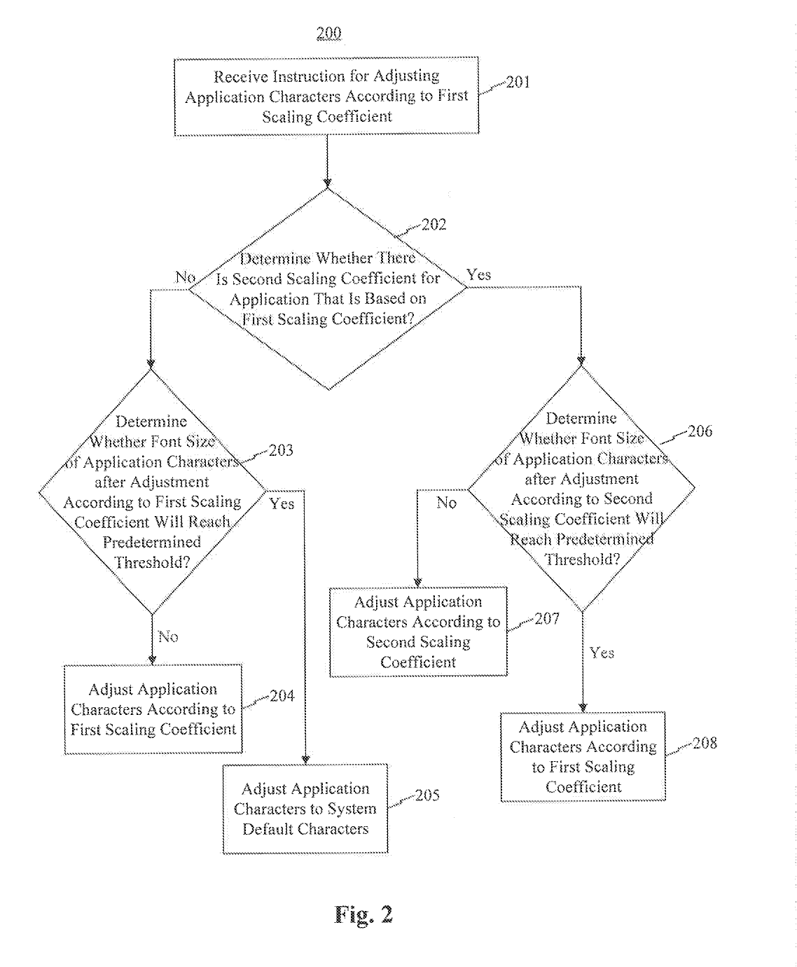

FIG. 2 is a flowchart of a method 200 for adjusting characters of an application that are displayed on a device, referred to hereafter as the application characters, according to an exemplary embodiment. Referring to FIG. 2, the method 200 includes the following steps.

In step 201, the device receives an instruction for adjusting the application characters according to a first scaling coefficient.

In one exemplary embodiment, the user accesses a character system mode menu level by level through a main menu. The character system mode menu provides respective options for character system modes, such as a small font mode, a standard font mode, an intermediate font mode, a large font mode and an ultra-large font mode. The user can select a character system mode, such as the large font mode. The device enters into the large font mode, and checks a correspondence between the selected character system mode and a first scaling coefficient to obtain the first scaling coefficient corresponding to the selected character system mode, e.g., obtain a first scaling coefficient 13 corresponding to the selected large font mode. The instruction for adjusting the application characters according to the first scaling coefficient is sent to a processor of the device. The processor receives the instruction for adjusting the application characters according to the first scaling coefficient.

In step 202, the device determines whether there is a second scaling coefficient for the application that is based on the first scaling coefficient.

The device performs step 203 if it is determined that there is no second scaling coefficient for the application that is based on the first scaling coefficient (202—No). Otherwise (202—Yes), the device performs step 206.

In one exemplary embodiment, in performing step 202, the device uses the Android operating system, and descriptive information in an Androidmanifest.xml file of the application is obtained. The device determines that the application characters may be further scaled if a value of the descriptive information of the Androidmanifest.xml file is, e.g., 1, and then checks a correspondence between the selected character system mode and a second scaling coefficient to obtain the second scaling coefficient, e.g., 1.4, for the selected large font mode. If the value of the descriptive information of the Androidmanifest.xml file is, e.g., 0, the device determines that the application characters are not allowed to be further scaled. Accordingly, the device determines that there is no second scaling coefficient for the application.

In step 203, it is determined whether a font size of the application characters after the adjustment according to the first scaling coefficient will reach the predetermined threshold.

If it is determined that the font size of the application characters after the adjustment will not reach the predetermined threshold (203—No), in step 204, the application characters are adjusted according to the first scaling coefficient and operations end.

In one exemplary embodiment, the font size and the layout of the application characters are adjusted according to the first scaling coefficient. For example, the correspondence between stored scaling coefficients and the application's character libraries is searched to obtain a character library corresponding to the first scaling coefficient, e.g., a character library corresponding to 1.3 times the system default characters, and the application characters are adjusted to the font size and the layout corresponding to 1.3 times the system default characters.

If it is determined that the font size of the application's characters after the adjustment will reach the predetermined threshold (203—Yes), in step 205, the application characters are adjusted to the system default characters and operations end.

In the illustrated embodiment, prior to adjusting the application characters according to the first scaling coefficient, the adjustment process is intelligently controlled, that is, if the font size of the application characters after adjustment will reach the predetermined threshold, the adjustment is not implemented and the application characters are adjusted to the system default characters, to ensure the display effect of the application characters after scaling, and avoid blurring of the application's characters due to over scaling.

In step 206, if it is determined that there is a second scaling coefficient for the application that is based on the first scaling coefficient (202—Yes), it is further determined whether the font size of the application characters after the adjustment according to the second scaling coefficient will reach the predetermined threshold.

If it is determined that the font size of the application characters after the adjustment will not reach the predetermined threshold (206—No), in step 207, the application characters are adjusted according to the second scaling coefficient and operations end.

In one exemplary embodiment, consistent with step 207, the font size and the layout of the application's characters are adjusted according to the second scaling coefficient. For example, a character library corresponding to the second scaling coefficient is obtained through checking the correspondence between scaling coefficients and character libraries. For example, the character library corresponding to 1.4 times the system default characters is obtained, and the application's characters are adjusted to the font size and the layout corresponding to 1.4 times the system default characters.

If it is determined that the font size of the application characters after the adjustment will reach the predetermined threshold (206—Yes), in step 208, the application characters are adjusted according to the first scaling coefficient and operations end.

In one exemplary embodiment, consistent with step 208, prior to adjusting the application characters according to the first scaling coefficient in step 208, steps 203 to 205 are also performed to ensure the font size of the application characters will not exceed the predetermined threshold after the application characters are adjusted according to the first scaling coefficient.

In the illustrated embodiment, prior to adjusting the application characters according to the second scaling coefficient, the adjustment process is intelligently controlled, that is, if the font size of the application characters will reach the predetermined threshold, the application characters are adjusted according to the first scaling coefficient, to ensure the display effect of the application characters after scaling, and to avoid blurring of the application characters due to over scaling.

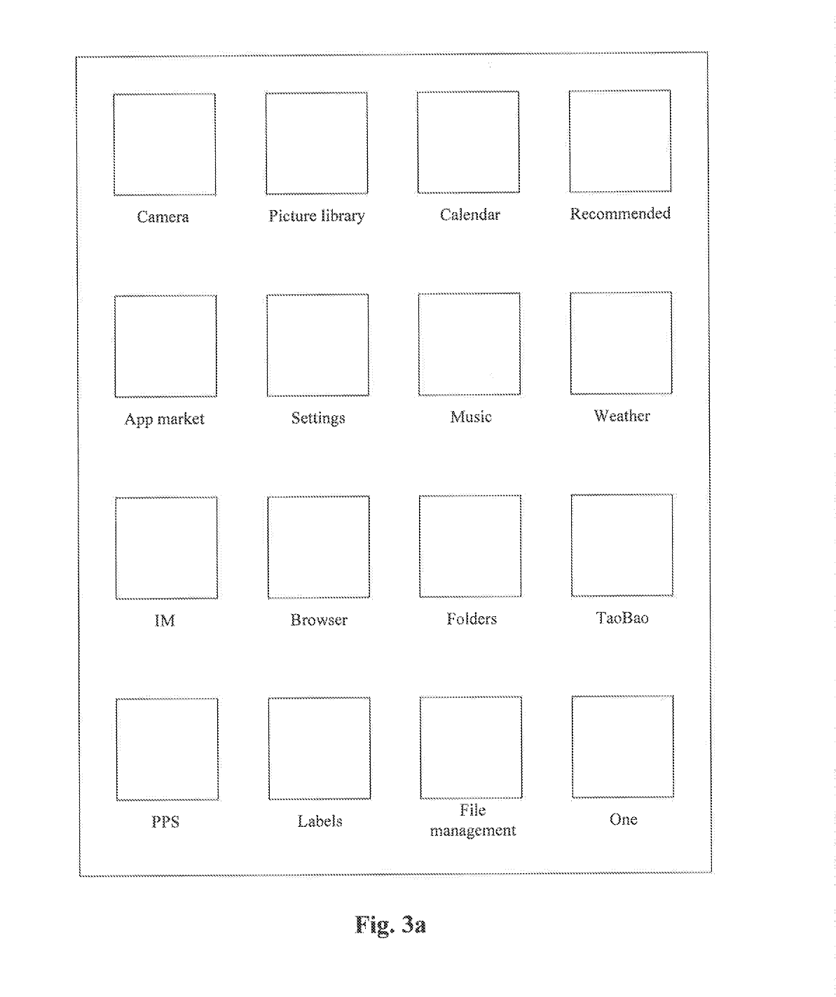

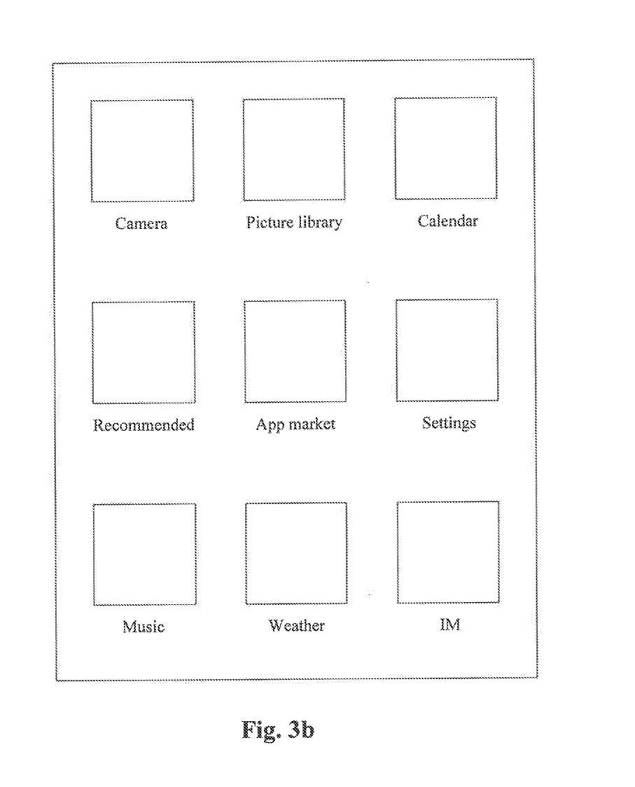

In one exemplary embodiment, the device is a cell phone, and the user wants to adjust characters of applications displayed on a desktop. For example, the user selects to adjust the applications characters to the large font mode through the selection menu. The cell phone checks a first scaling coefficient corresponding to the large font mode, such as 1.3, after receiving an instruction for adjusting the applications characters to the large font mode. Thereafter, the applications characters are magnified according to the first scaling coefficient, which may include magnifying the font size and the layout (including an icon size) of the applications. FIG. 3a is a schematic diagram of a display of characters of the applications in a normal font, according to an exemplary embodiment. In FIG. 3a, a font size and an icon size of each application are system default standard sizes, and the applications are displayed on the desktop in a 4 by 4 display grid. FIG. 3h is a schematic diagram of a display of characters of the applications after magnifying the applications characters in FIG. 3a by a factor of 1.3, according to an exemplary embodiment. In FIG. 3h, the applications are displayed on the desktop in a 3 by 3 display grid, and the applications' font size and icons are enlarged by 1.3 times with respect to those in FIG. 3a. As shown in FIG. 3b, after the applications characters are enlarged, the display grid on the desktop and the icon size also change. In addition, if a character string corresponding to an icon is longer than the length that can be displayed, the extra portion of the character string may be hidden such that no characters will overlap.

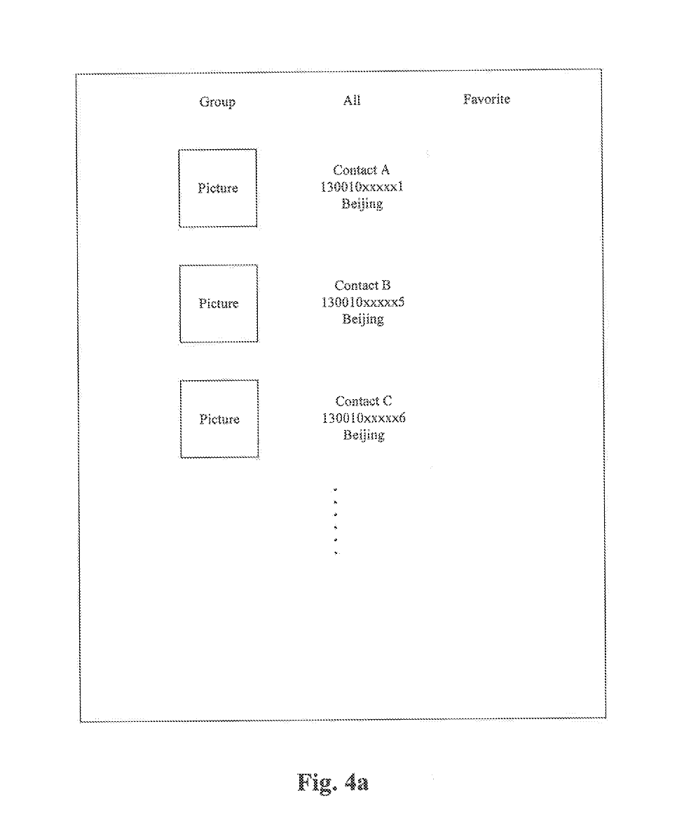

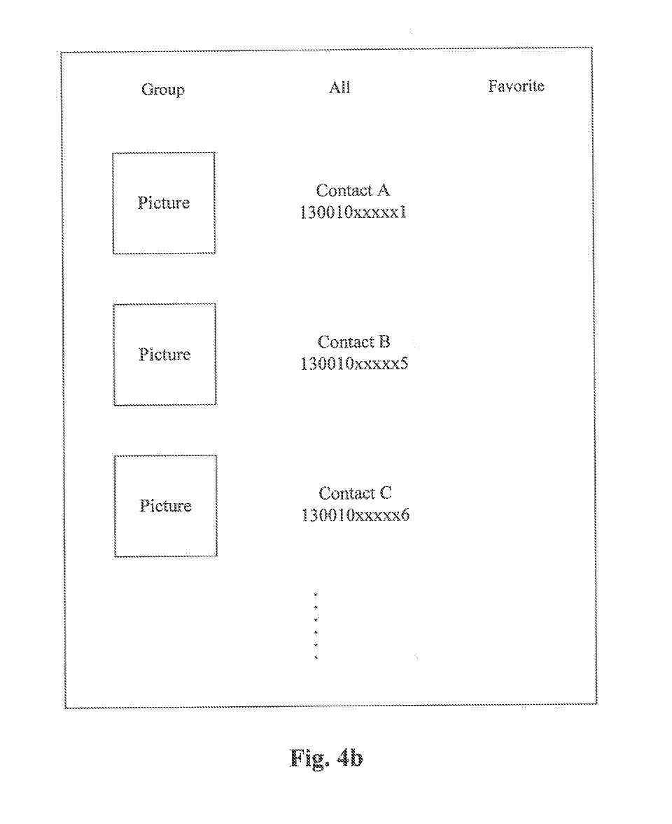

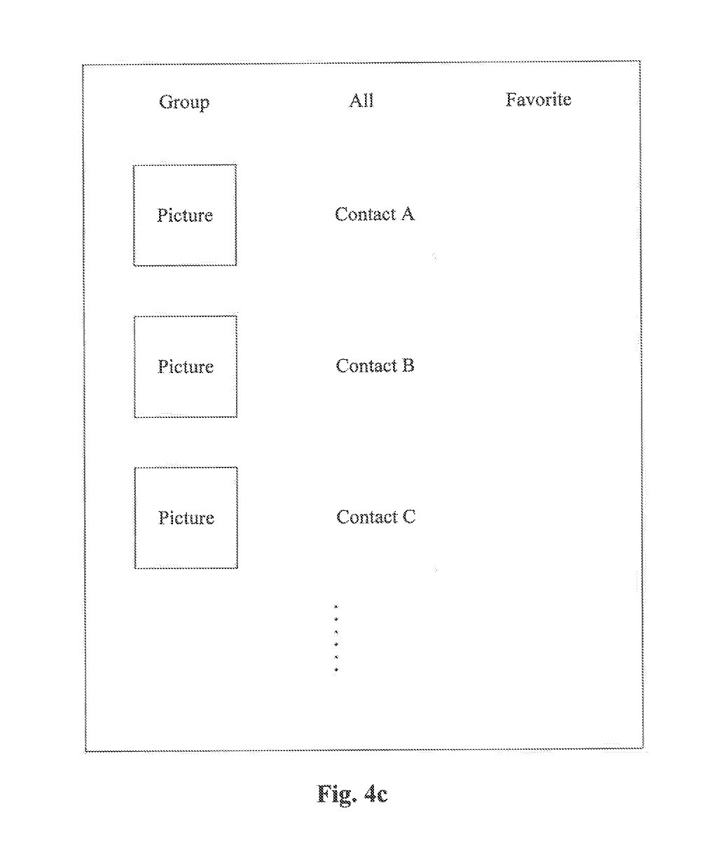

In one exemplary embodiment, the user wants to adjust characters of an address book installed on the cell phone. For example, the user selects to adjust the address book's characters to the large font mode through the selection menu. The cell phone obtains a first scaling coefficient corresponding to the large font mode, such as 1.3, after receiving an instruction for adjusting the address book's characters to the large font mode. Thereafter, the address book's characters are magnified according to the first scaling coefficient, which may include magnifying the font size, the content, the layout, the picture size, and the interaction function display of the address book. FIG. 4a is a schematic diagram of a display of the address book's characters in a normal font, according to an exemplary embodiment. In FIG. 4a, the address book's font size and picture size are system default sizes and the layout in the address book includes picture, name, displayed number and region. FIG. 4b is a schematic diagram of a display of characters, after magnifying the address book's characters in FIG. 4a by a factor of 1.3 to a large font, according to an exemplary embodiment. In FIG. 4b, the layout in the address book becomes picture, name and displayed number and the region is hidden, and the characters' font size and the pictures are magnified by a factor of 1.3 with respect to those in FIG. 4a. As shown in FIG. 4b, after the applications characters are magnified, the display grid on the desktop and the icon size also change.

In the illustrated embodiment, a second magnification may be performed on the characters in the address book shown in FIG. 4b, such as further magnifying by 10%, if a second scaling coefficient, e.g., 1.4, under the large font mode is obtained, and it is determined that the standard font shown in FIG. 4a will not exceed the predetermined threshold after being magnified by 1.4 times. FIG. 4c is a schematic diagram of a display of the address book after the second magnification, according to an exemplary embodiment. In FIG. 4c, the layout of the address book becomes picture and name, and the displayed number is also hidden. The font size of the characters and the picture size are 1.4 times larger than those in FIGS. 4a, and 10% larger than those in FIG. 4b.

In the illustrated embodiment, when the cell phone receives the instruction for adjusting the application characters according to the first scaling coefficient, and determines that there is a second scaling coefficient for the application that is based on the first scaling coefficient, the cell phone adjusts the application characters according to the second scaling coefficient. If it is determined that there is no second scaling coefficient for the application, the cell phone adjusts the application characters according to the first scaling coefficient. The application characters are flexibly adjusted to allow the application characters to fit the application's display interface and to prevent the characters from being cropped or forced out of the screen of the cell phone after the adjustment.

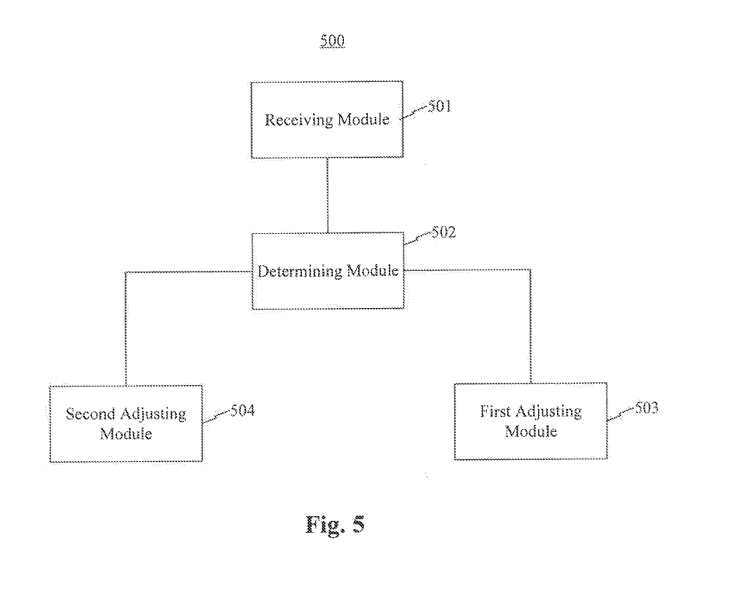

FIG. 5 is a block diagram of an apparatus 500 for adjusting characters of an application that are displayed on the apparatus 500 or a device including the apparatus 500, referred to hereafter as the application characters, according to an exemplary embodiment. Referring to FIG. 5, the apparatus 500 includes a receiving module 501 configured to receive an instruction for adjusting the application characters according to a first scaling coefficient, a determining module 502 configured to determine whether there is a second scaling coefficient for the application that is based on the first scaling coefficient, a first adjusting module 503 configured to adjust the application characters according to the first scaling coefficient if it is determined that there is no second scaling coefficient for the application, and a second adjusting module 504 configured to adjust the application characters according to the second scaling coefficient if it is determined that there is a second scaling coefficient for the application that is based on the first scaling coefficient.

In one exemplary embodiment, the receiving module 501 is configured to receive the instruction for adjusting the application characters according to the first scaling coefficient via a set human-machine interaction interface, and the human-machine interaction interface is one of a selection menu of scaling coefficients, a selection icon of the first scaling coefficient, or a selection key of scaling coefficients.

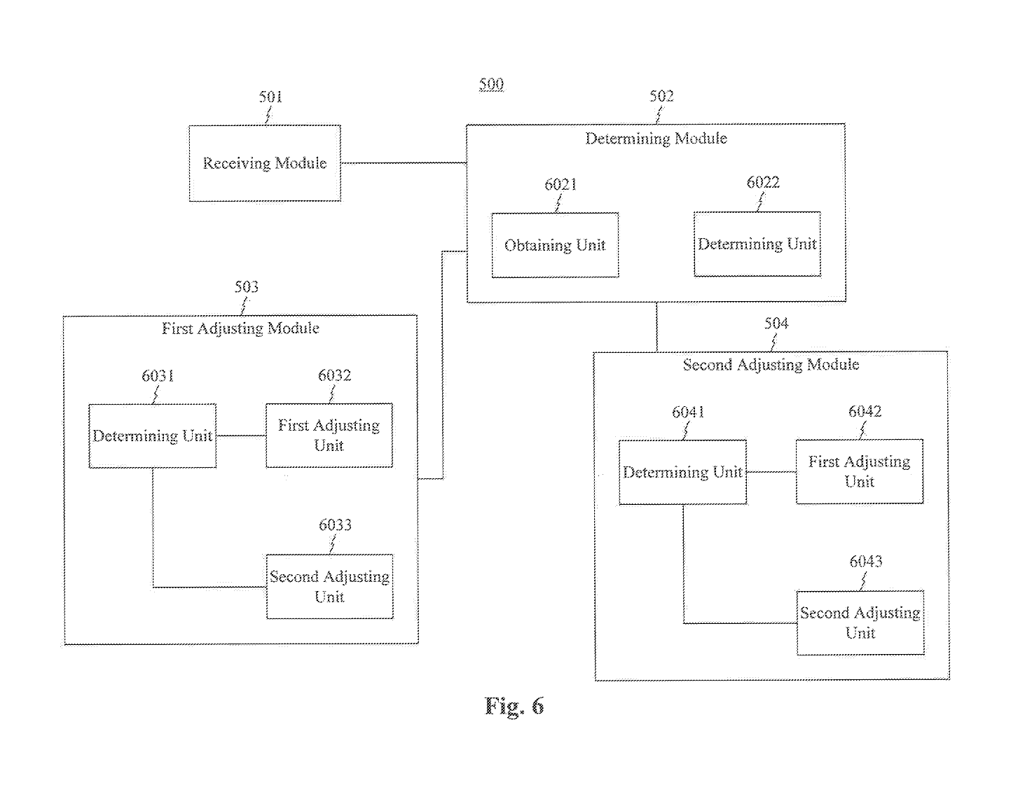

FIG. 6 is a block diagram of the apparatus 500 for adjusting the application characters, according to another exemplary embodiment. Referring to FIG. 6, the determining module 502 includes an obtaining unit 6021 configured to obtain descriptive information in a scaling permission description field of the application, and a determining unit 6022 configured to determine whether there is a second scaling coefficient for the application that is based on the first scaling coefficient according to the descriptive information.

The first adjusting module 503 includes a determining unit 6031 configured to determine whether a font size of the application characters will reach a predetermined threshold after the adjustment according to the first scaling coefficient, a first adjusting unit 6032 configured to adjust the application characters according to the first scaling coefficient if it is determined that the font size of the application characters will not reach the predetermined threshold, and a second adjusting unit 6033 configured to adjust the application characters to system default characters if it is determined that the font size of the application characters will reach the predetermined threshold.

The second adjusting module 504 includes a determining unit 6041 configured to determine whether the font size of the application characters will reach the predetermined threshold after the adjustment according to the second scaling coefficient, a first adjusting unit 6042 configured to adjust the application characters according to the second scaling coefficient if it is determined that the font size of the application characters will not reach the predetermined threshold, and a second adjusting unit 6043 configured to adjust the application characters according to the first scaling coefficient if it is determined that the font size of the application characters will reach the predetermined threshold.

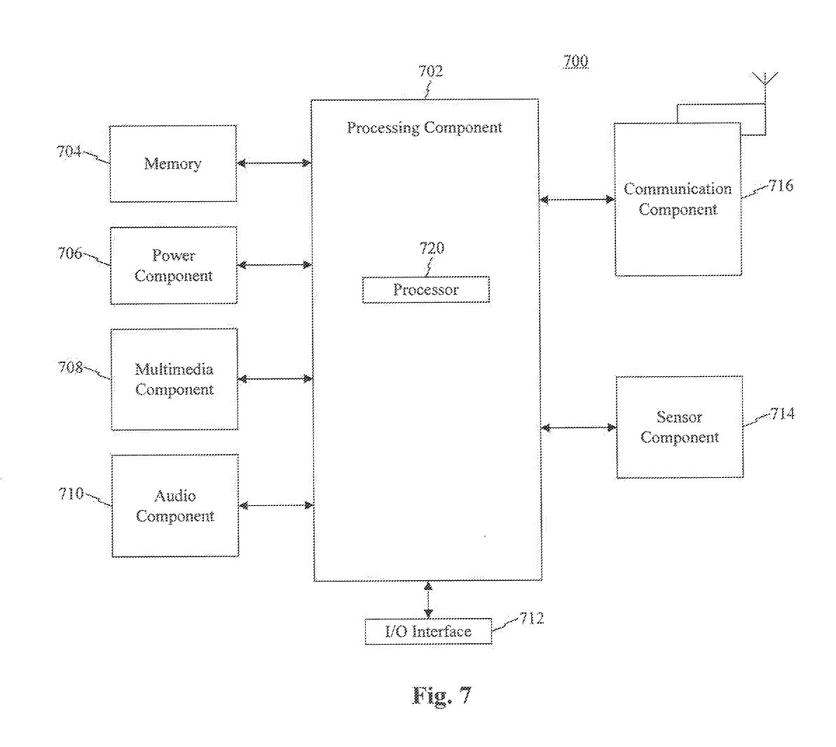

FIG. 7 is a block diagram of a device 700 for adjusting characters of an application that are displayed on the device 700, referred to hereafter as the application characters, according to an exemplary embodiment. For example, the device 700 may be a mobile phone, a computer, a digital broadcast terminal, a messaging device, a gaming console, a tablet, a medical device, exercise equipment, a personal digital assistant, and the like.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the device 700, such as the operations associated with display, telephone calls, data communications, camera operations, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, and a magnetic or optical disk.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user, in some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the device 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may detect an open/closed status of the device 700, relative positioning of components, e.g., the display and the keypad, of the device 700, a change in position of the device 700 or a component of the device 700, a presence or absence of user contact with the device 700, an orientation or an acceleration/deceleration of the device 700, and a change in temperature of the device 700. The sensor component 714 may include a proximity sensor configured to detect the presence of nearby objects without any physical contact. The sensor component 714 may also include a light sensor, such as a CMOS or CCD image sensor, for use in imaging applications, in some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the device 700 and other devices. The device 700 can access a wireless network based on a communication standard, such as WiFi, 20, or 3G, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NEC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 704, executable by the processor 720 in the device 700, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

One of ordinary skill in the art will understand that modules in the apparatus 500 (FIGS. 5 and 6) may be distributed in the device including the apparatus 500, and may also be modified to be located in one or more devices other than the device including the apparatus 500.

One of ordinary skill in the art will understand that, although described based on characters of an application that are displayed on a device, the above methods can be applied to any characters or images displayed on the device.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for adjusting characters of an application that are displayed on a device, comprising:
receiving an instruction for adjusting the characters of the application according to a first scaling coefficient;
determining whether there is a second scaling coefficient, for the application, that is based on the first scaling coefficient;
adjusting the characters of the application according to the first scaling coefficient if it is determined that there is no second scaling coefficient, for the application, that is based on the first scaling coefficient; and
adjusting the characters of the application according to the second scaling coefficient if it is determined that there is a second scaling coefficient, for the application, that is based on the first scaling coefficient.

2. The method of claim 1, wherein the receiving of the instruction comprises:
receiving the instruction for adjusting the characters of the application according to the first scaling coefficient via one of a selection menu including the first scaling coefficient, a selection icon corresponding to the first scaling coefficient, or a selection key corresponding to the first scaling coefficient.

3. The method of claim 1, wherein the determining comprises:
obtaining descriptive information in a scaling permission description field of the application; and
determining whether there is the second scaling coefficient according to the descriptive information.

4. The method of claim 1, further comprising:
determining whether a font size of the characters of the application will reach a predetermined threshold if the adjusting of the characters according to the second scaling coefficient is performed;
adjusting the characters of the application according to the second scaling coefficient if it is determined that the font size will not reach the predetermined threshold; and
adjusting the characters of the application according to the first scaling coefficient if it is determined that the font size will reach the predetermined threshold.

5. The method of claim 1, further comprising:
determining whether a font size of the characters of the application will reach a predetermined threshold if the adjusting of the characters according to the first scaling coefficient is performed;
adjusting the characters of the application according to the first scaling coefficient if it is determined that the font size will not reach the predetermined threshold; and
adjusting the characters of the application to system default characters if it is determined that the font size will reach the predetermined threshold.

6. The method of claim 1, wherein the adjusting of the characters of the application according to the first scaling coefficient comprises:
adjusting a font size and a layout of the characters of the application.

7. The method of claim 4, wherein the font size is a first font size, the method further comprising:
determining whether a second font size of the characters of the application will reach the predetermined threshold if the adjusting of the characters according to the first scaling coefficient is performed;
adjusting the characters of the application according to the first scaling coefficient if it is determined that the second font size will not reach the predetermined threshold; and
adjusting the characters of the application to system default characters if it is determined that the second font size will reach the predetermined threshold.

8. The method of claim 1, wherein the adjusting of the characters of the application according to the second scaling coefficient comprises:
adjusting a font size and a layout of the characters of the application.

9. A device for adjusting characters of an application that are displayed on the device, comprising:
a processor; and
a memory for storing instructions executable by the processor;
wherein the processor is configured to:
receive an instruction for adjusting the characters of the application according to a first scaling coefficient;
determine whether there is a second scaling coefficient, for the application, that is based on the first scaling coefficient;
adjust the characters of the application according to the first scaling coefficient if it is determined that there is no second scaling coefficient, for the application, that is based on the first scaling coefficient; and
adjust the characters of the application according to the second scaling coefficient if it is determined that there is a second scaling coefficient, for the application, that is based on the first scaling coefficient.

10. The device of claim 9, wherein the processor is further configured to:
obtain descriptive information in a scaling permission description field of the application; and
determine whether there is the second scaling coefficient according to the descriptive information.

11. The device of claim 9, wherein the processor is further configured to:
determine whether a font size of the characters of the application will reach a predetermined threshold if the adjusting of the characters according to the second scaling coefficient is performed;
adjust the characters of the application according to the second scaling coefficient if it is determined that the font size will not reach the predetermined threshold; and
adjust the characters of the application according to the first scaling coefficient if it is determined that the font size will reach the predetermined threshold.

12. The device of claim 9, wherein the processor is further configured to:
determine whether a font size of the characters of the application will reach a predetermined threshold if the adjusting of the characters according to the first scaling coefficient is performed;
adjust the characters of the application according to the first scaling coefficient if it is determined that the font size will not reach the predetermined threshold; and
adjust the characters of the application to system default characters if it is determined that the font size will reach the predetermined threshold.

13. The device of claim 9, wherein the processor is further configured to:
adjust a font size and a layout of the characters of the application according to the first scaling coefficient.

14. The device of claim 11, wherein the processor is further configured to:
determine whether a second font size of the characters of the application will reach the predetermined threshold if the adjusting of the characters according to the first scaling coefficient is performed;
adjust the characters of the application according to the first scaling coefficient if it is determined that the second font size will not reach the predetermined threshold; and
adjust the characters of the application to system default characters if it is determined that the second font size will reach the predetermined threshold.

15. The device of claim 9, wherein the processor is further configured to:
adjust a font size and a layout of the characters of the application according to the second scaling coefficient.

16. A non-transitory computer-readable storage medium having stored therein instructions that, when executed by a processor of a device, cause the device to perform a method for adjusting characters of an application displayed on the device, the method comprising:
receiving an instruction for adjusting the characters of the application according to a first scaling coefficient;
determining whether there is a second scaling coefficient, for the application, that is based on the first scaling coefficient;
adjusting the characters of the application according to the first scaling coefficient if it is determined that there is no second scaling coefficient, for the application, that is based on the first scaling coefficient; and
adjusting the characters of the application according to the second scaling coefficient if it is determined that there is a second scaling coefficient, for the application, that is based on the first scaling coefficient.

17. The non-transitory computer-readable storage medium of claim 16, wherein the determining comprises:
obtaining descriptive information in a scaling permission description field of the application; and
determining whether there is the second scaling coefficient according to the descriptive information.

18. The non-transitory computer-readable storage medium of claim 16, wherein the method further comprises:
determining whether a font size of the characters of the application will reach a predetermined threshold if the adjusting of the characters according to the second scaling coefficient is performed;
adjusting the characters of the application according to the second scaling coefficient if it is determined that the font size will not reach the predetermined threshold; and
adjusting the characters of the application according to the first scaling coefficient if it is determined that the font size will reach the predetermined threshold.

19. The non-transitory computer-readable storage medium of claim 16, wherein the method further comprises:
determining whether a font size of the characters of the application will reach a predetermined threshold if the adjusting of the characters according to the first scaling coefficient is performed;
adjusting the characters of the application according to the first scaling coefficient if it is determined that the font size will not reach the predetermined threshold; and
adjusting the characters of the application to system default characters if it is determined that the font size will reach the predetermined threshold.

20. The non-transitory computer-readable storage medium of claim 1$, wherein the font size is a first font size, the method further comprising:
determining whether a second font size of the characters of the application will reach the predetermined threshold if the adjusting of the characters according to the first scaling coefficient is performed;
adjusting the characters of the application according to the first scaling coefficient if it is determined that the second font size will not reach the predetermined threshold; and
adjusting the characters of the application to system default characters if it is determined that the second font size will reach the predetermined threshold.
